(19) United States
(12) Patent Application Publication
(10) Pub. No.: US 2017/0083666 A1
(43) Pub. Date: Mar. 23, 2017

(54) PRESURGICAL PLANNING FOR USE DURING SURGICAL PROCEDURE

(71) Applicant: NOVARTIS AG, Basel (CH)

(72) Inventors: PHILIP BIANCALANA, KELLER, TX (US); PAUL R. HALLEN, COLLEYVILLE, TX (US); MARK ALAN HOPKINS, MISSION VIEJO, CA (US); ARGELIO MICHAEL OLIVERA, MISSION VIEJO, CA (US); MICHAEL JAMES PAPAC, NORTH TUSTIN, CA (US); ROBERT JOSEPH SANCHEZ, JR., OCEANSIDE, CA (US)

(21) Appl. No.: 15/067,980

(22) Filed: Mar. 11, 2016

Related U.S. Application Data
(60) Provisional application No. 62/222,027, filed on Sep. 22, 2015.

(51) Int. Cl. G06F 19/00

(52) U.S. Cl. CPC G06F 19/322; G06F 19/321

(57) ABSTRACT

Devices, systems, and methods for generating presurgical planning material, annotating the presurgical planning material, and using that generated presurgical planning materials during a surgical procedure are disclosed. The presurgical planning material may be annotated at a location outside of a sterile surgical environment. The annotated presurgical planning material may be displayed on a display device within a sterile surgical environment during a surgical procedure to assist a user, such as a surgeon or other medical professional, in performing the surgical procedure.

### TECHNICAL FIELD

The present disclosure relates to systems, devices, and methods for generating presurgical planning materials, annotating the presurgical planning materials, and utilizing the annotated presurgical planning materials during a surgical procedure.

### SUMMARY

A first aspect of the present disclosure may include a surgical system that may include a first computer-implemented device operable to obtain biomedical information of a patient and store the biomedical information in a digital format to form presurgical planning material; a second computer-implemented device operable to generate and incorporate an annotation into the presurgical planning material based on received user inputs to form annotated presurgical planning materials, the annotations providing informational aids to assist a medical professional in conducting a surgical procedure; and a third computer-implemented device operable to recall and present to a user the annotated presurgical planning materials in an electronic format in a sterile surgical environment.

According to another aspect, the disclosure describes a method of preparing annotated presurgical planning materials and presenting the annotated presurgical planning materials in a sterile surgical environment. The method may include interfacing with a first computer-implemented device to capture presurgical planning material comprising biomedical information; interfacing with a second computer-implemented device to annotate the presurgical planning material to form annotated presurgical planning material; and interfacing with a third computer-implemented device to display electronically the annotated presurgical planning material inside of a sterile surgical environment.

The various aspects may include one or more of the following features. The first computer-implemented device may include an imaging device operable to capture an image of a surgical site prior to a surgical procedure. The first computer-implemented device may include an imaging device operable to capture an image of a surgical site prior to a surgical procedure. The annotation may include medically-related information associated with the surgical procedure to assist a user in conducting the surgical procedure. The first computer-implemented device, the second computer-implemented device, and the third computer-implemented device may be electronically connected via a computer network. The second computer-implemented device may be located outside of a sterile surgical environment. The third computer-implemented device may include a surgical console. The surgical console may include a display operable to display the annotated presurgical planning material. The first computer-implemented device, the second computer-implemented device, and the third computer-implemented device may be the same computer-implemented device.

The various aspects may also include one or more of the following features. Interfacing with a first computer-implemented device to capture presurgical planning material that includes biomedical information may include capturing an image of a surgical site prior to a surgical procedure. The first computer-implemented device may be a visualization device, and the image of the surgical site may be an image of an ocular tissue. Interfacing with a second computer-implemented device to annotate the presurgical planning material to form annotated presurgical planning material may include adding medically-related information associated with the surgical procedure to the presurgical planning material to assist a user in conducting the surgical procedure. Interfacing with a third computer-implemented device to display the annotated presurgical planning material inside of a sterile surgical environment may include displaying the annotated presurgical planning material on a display device of the third computer-implemented device. The third computer-implemented device may be a visualization device, and the display device may be an eyepiece of the visualization device. The first computer-implemented device, the second computer-implemented device, and the third computer-implemented device may be the same device. The first computer-implemented device, the second computer-implemented device, and the third computer-implemented device may be electronically connected via a computer network. At least one of the first computer-implemented device, the second computer-implemented device, and the third computer-implemented device may be a different device from one or more of the other of the first computer-implemented device, the second computer-implemented device, and the third computer-implemented device.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is an example system that may be used to perform surgical procedures.

FIG. 2 shows an example annotated presurgical planning material in the form of an annotated image of a portion of a retina.

FIG. 3 is an example flowchart of an example method for preparing annotated presurgical planning material and utilizing the annotated presurgical planning material during a surgical procedure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure relates to systems, methods, and devices for generating presurgical planning material, annotating the presurgical planning material to form annotated presurgical planning materials, and using that generated presurgical planning materials during a surgical procedure. Particularly, the present disclosure describes methods, apparatuses, and systems to prepare presurgical planning materials in a digital format that can be recalled during the surgical procedure by a user, such as a physician or other medical professional, using a display device.

Presurgical planning material may include various forms of data. Particularly, the presurgical planning material may be biomedical information that represents or reflects one or more aspects of a patient's anatomy and/or physiology, for example. For example, the data may include Optical Coherence Tomography (OCT) imaging data, multispectral imaging data, ultrasound imaging data, fundus imaging data, or any other imaging data or other type of data that a physician or other medical professional may obtain in the course of treating a patient or otherwise find useful in treating a patient.

The presurgical planning material may be in the form of digital data. For example, while much of the planning material may be in the form of imaging data, the scope of the planning material is not so limited. Rather, the planning material may include medical test data or other information that a physician may determine to be useful in preparing for a surgical procedure. Moreover, while the examples provided herein are focused mainly on ophthalmology, the scope of the disclosure is applicable to any area of medicine and/or any form of surgery or patient treatment. Therefore, other types of medical procedures are within the scope of the present disclosure.

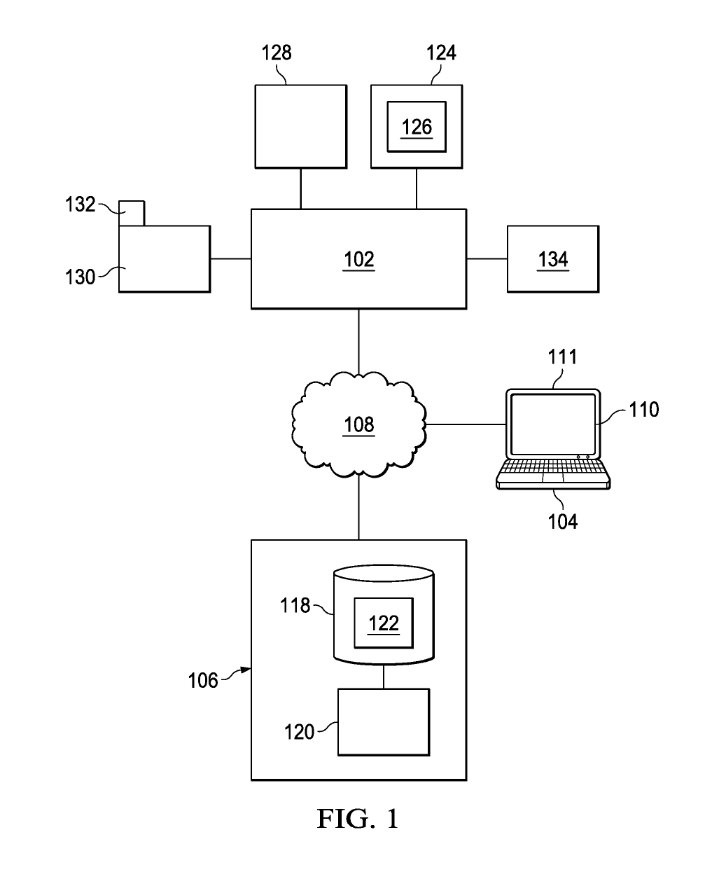

FIG. 1 shows an example system 100 that may be used to perform surgical procedures, including presurgical planning of a surgical procedure. The system 100 may include a surgical device 102, a computer 104, and a server 106. The surgical device 102, the computer 104, and servicer 106 may be joined via a network 108.

The computer 104 may be any computing device operable to connect or communicate with the surgical device 102 or network 108 using any communication link. For example, computer 104 may include a desktop computer, a laptop computer, a mobile computing device, a tablet computing device, or any other type of computer device. In some instances, computer 104 may include an electronic computing device operable to receive, transmit, process, and store any appropriate data associated with system 100. It will be understood that there may be any number of computers 104 communicably coupled to network 108. Computer 104 may also include or execute a GUI 110 on a display 111.

GUI 110 may include a graphical user interface operable to allow the user, such as a medical practitioner, to interface with the computer 104 or system 100 for any suitable purpose, such as viewing application or other system information. For example, GUI 110 could provide information associated with a medical procedure, including providing planning material to a surgeon prior to a surgical procedure. For example, the GUI 110 could be operable to display the various types of imaging data that a user may desire to review prior to a surgical procedure and permit the user to add, change, or remove an annotation to the imaging data. More generally, the GUI 110 may also be operable to permit the user to annotate any type of planning material, such as, for example, by adding, changing, or removing an annotation from presurgical planning material. The GUI 110 may also provide operability to permit the user to save the annotated presurgical planning material for subsequent use, such as during a surgical procedure.

Generally, GUI 110 may provide a user with an efficient and user-friendly presentation of information received by, provided by, or communicated within system 100. GUI 110 may include a plurality of customizable frames or views having, for example, interactive fields, pull-down lists, and buttons operated by the user. GUI 110 may also present a plurality of portals or dashboards. In some instances, the GUI 110 may include a generic web browser, application interface, or touch screen that processes information in system 100 and efficiently presents the results to the user. The GUI 110 may include a custom or customizable interface for displaying and/or interacting with the various features of an application (such as application 122 discussed in more detail below) or other system services. Therefore, GUI 110 contemplates any graphical user interface.

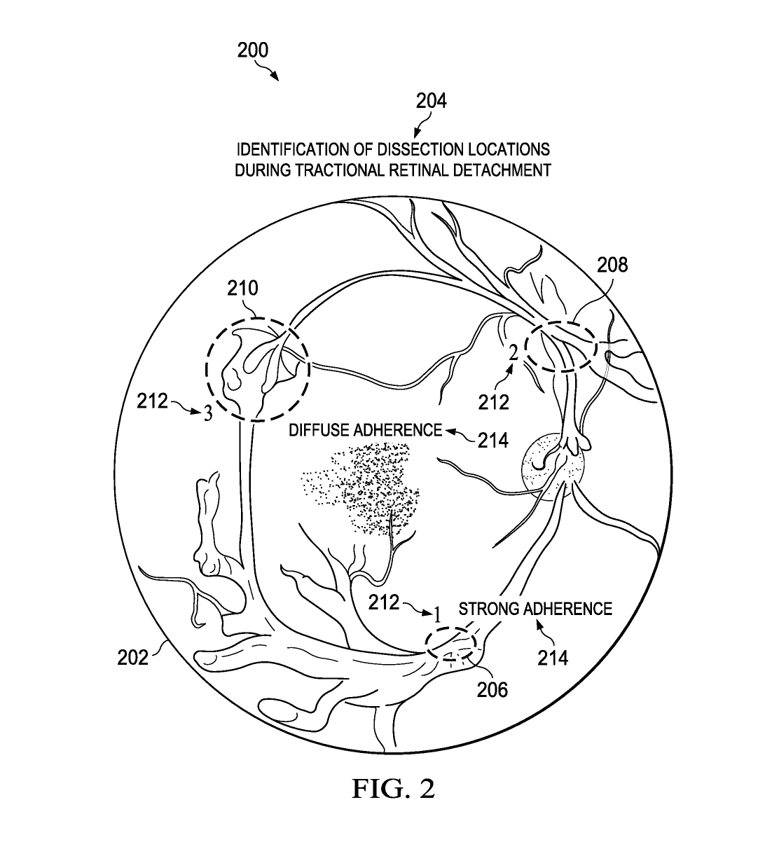

The server 106 may include a memory 118 and a processor 120. The server 106 may be operable to receive, transmit, process, and store data associated with system 100. Generally, FIG. 1 provides merely one example of a server within the scope of the disclosure. The server 106 is generally intended to encompass any suitable processing device. For example, although FIG. 2 illustrates an example server 106 that may be included within the system 100, system 100 can be implemented using other types of servers. In still other implementations, system 100 may not include a server.

The display 111 displays information to a user. In some instances, the display 111 may be a monitor (such as a liquid crystal display, plasma screen, or cathode ray tube (CRT)) or any other visual display device for visually displaying information, such as the presurgical planning data and annotated presurgical planning data. In some instances, the display 111 may operate both as a display and an input device. For example, the display 111 may be a touch sensitive display in which a touch by a user or other contact with the display produces an input to the system 100. The display 111 may present information to the user via a graphical user interface or application interface (collectively referred to as “GUI 110”). In some instances, the display 111 may be three-dimensional (“3D”) viewing system, heads-up-display, or other viewing device operable to display an image.

Server 106 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 106 may be adapted to execute any operating system including Linux, UNIX, Windows Server, or any other suitable operating system. According to one embodiment, server 106 may also include or be communicably coupled with a web server and/or a mail server.

Memory 118 may include any memory or database module and may take the form of volatile or non-volatile memory including, without limitation, magnetic media, optical media, random access memory (RAM), read-only memory (ROM), removable media, or any other suitable local or remote memory component. Illustrated memory 118 may include, among other items, a presurgical planning application 122. The application 122 may be operable to permit a user to recall presurgical planning material, such as one or more of the data types described herein, manipulate and/or annotate the presurgical planning material, and store the annotated presurgical planning material for later recall during a surgical procedure, for example. In some implementations, application 122 may be a single application. In other instances, application 122 may refer to a collection of applications that includes functionality for annotating presurgical planning materials. Further, although application 122 is shown as being located on or form part of the memory 118, it is within the scope of the disclosure that the application 122 may be separate from memory 118 and may include software, hardware, or a combination thereof

Memory 118 may store other types of data. For example, memory 118 may also include data that can be utilized by the application 122. In some instances, the presurgical planning material, the annotated presurgical planning material, or both may also be stored on the memory 118. In other instances, some or all of the presurgical planning material, annotated presurgical planning material, both, or some portion of either or both may be stored remote from the memory 118. For example, all or a portion of the presurgical planning material or annotated presurgical planning material may be stored in memory on computer 104, in memory on the surgical device 102, or some other device connected to the network 108. Further, in some instances, the presurgical planning material or annotated presurgical planning material may be accessible from any of the computer 104, the server 106, the surgical device 102, or any authorized device connected to the network 108.

Memory 118 may also include other types of data, such as environment and/or application description data, application data for one or more applications, as well as data involving virtual private network (VPN) applications or services, firewall policies, a security or access log, print or other reporting files, HyperText Markup Language (HTML) files or templates, related or unrelated software applications or sub-systems, and others. Consequently, memory 118 may also be considered a repository of data, such as a local data repository from one or more applications.

Processor 120 executes instructions and manipulates data to perform the operations of the system 100, e.g., computational and logic operations, and may be, for example, a central processing unit (CPU), a blade, an application specific integrated circuit (ASIC), or a field-programmable gate array (FPGA). Although FIG. 1 illustrates a single processor 120, multiple processors may be used according to particular needs and reference to processor 120 is meant to include multiple processors where applicable. For example, the processor 120 may be adapted for receiving information from data from various components of the system 100, process the received data, and transmit data to one or more of the components of the system 100 in response thereto. For example, the processor 120 may send and/or receive data to and/or from the surgical device 102 and computer 104, as well as other components that may be included in the system 100. The processor 120 may execute application 122 to perform annotations of presurgical planning materials and send and receive data, such as presurgical planning material and annotated presurgical planning material, to portions of the system 100.

The computer 104 and surgical device 102 may also include a memory and processor similar to memory 118 and processor 120 described herein. Therefore, one or more or all of the functions explained above in the context of the process 120 of the server 106 may be performed entirely or in part by the computer 104 or the surgical device 102 or any authorized device connected to the network 108. Further, while some implementations of the present disclosure may utilize a system such as the system 100 shown in FIG. 1, the scope of the disclosure is not so limited. Rather, in some instances, the surgical device 102 and a computer similar to computer 104 may be used independent of a server, such as server 106.

Thus, in some implementations, recall of presurgical planning materials, annotation of the presurgical planning materials, storage of the annotated presurgical planning materials, and the recall of the annotated presurgical planning materials, may be performed entirely on the surgical device 102. In other instances, a computer, such as computer 104, may be coupled to the surgical device 102 directly or via a network, such as network 108. The computer 104 may be used to recall the presurgical planning materials, annotate the presurgical planning materials, save the presurgical planning materials, and recall the annotated presurgical planning materials. The surgical device 102 may then be used to recall the annotated presurgical planning materials during a surgical procedure. In still other instances, the surgical device 102 may be used to recall the presurgical planning materials, annotate the presurgical planning materials, save the presurgical planning materials, recall the annotated presurgical planning materials, or any combination thereof.

In still other implementations, the presurgical planning materials may be created and/or modified by one or more devices connected to network 108. Still further, the surgical device 102 may be operable to generate one or more types of presurgical planning material and store all or a portion of that presurgical planning material in a memory of the surgical device 102, in the memory of computer 104, or in memory 118 of the server 106.

In some instance, the surgical device 102 may include a display 124, an input device 128, and a visualization device 130. The display 124 displays information to a user. The display 124 may be similar to display 111 and may be a monitor for visually displaying information. In some instances, the display 124 may operate both as a display and an input device. For example, the display 124 may be a touch sensitive display in which a touch by a user or other contact with the display produces an input to the system 100. Further, the surgical device 102 may execute or display a GUI 126 on the display 124. The GUI 126 may be similar to the GUI 110.

During a surgical procedure, a user, such as a surgeon, may utilize the display 124 to view and interact with the presurgical planning material, annotated presurgical planning material, or both. For example, where the display 124 is a touch screen display, the surgeon may recall and display the annotated presurgical planning material by interacting with GUI 126 by, touching one or more locations on the display 124. In other instances, the surgeon may recall and interact with the presurgical planning materials or annotated presurgical planning materials using the input device 128. In some instances, the input device 128 may be a mouse, joystick, or keypad. In other instances, the input device 128 may be a footswitch articulated by the surgeon's foot.

Although the input device 128 is described as being a mouse, joystick, keypad, or footswitch, the scope of the disclosure is not so limited. Rather, the input device 128 may be any input device operable to provide input to and/or receive feedback from the surgical device 102. For example, the input device 128 may also be a knob, dial, button, touchscreen or any other touch-sensitive device, or any other type of input device.

The visualization device 130 may be a microscope and be used to obtain a real-time image of a surgical site (“real-time surgical image”). For example, the visualization device 130 may be operable to obtain an image of a retina through the cornea and lens of the eye. The surgeon may view the retinal image via an eyepiece 132. In other instances, a real-time surgical image of the retina (or other surgical site) may be shown on the display 124. In other instances, both the eyepiece 132 and the display 124 may display a real-time surgical image of a retina or other surgical site.

Moreover, the eyepiece 132 of the visualization device 130 and the display 124 may be used to display the annotated presurgical planning material. The user may select one or both of eyepiece 132 and the display 124 to display the annotated presurgical planning material. Further, the eyepiece 132, the display 124, or both may be used to display both a real-time surgical image, such as a real-time image of a retina, as well as the annotated presurgical planning material.

In some instances, a separate display 134 may be provided. The separate display 134 may be included with the surgical device 102, or, in other instances, the separate display 134 may be separate from the surgical device 102. The second display 134 may be similar to displays 111 and 124. The display 134 may be operable to display one of annotated presurgical planning material or real-time surgical image while the display 124 may be operable to display the other of the real-time surgical image or annotated presurgical planning material. However, any of the display 124, the second display 134, or the eyepiece 132 may be operable to simultaneously display any of the presurgical planning material, the annotated presurgical planning material, the real-time surgical image, other information, or any combination thereof.

As a result, a user is able to review the real-time surgical image and the annotated presurgical planning materials simultaneously during the course of a surgical procedure. This allows the user to compare the real-time image presently being viewed with the annotated presurgical planning material and utilize the annotations made prior to surgery during the surgical procedure. As a result, the user is able to rely on information, such as presurgical images, data, and the analysis thereof, while performing the surgical procedure. The avoids the necessity of relying solely on a user's memory, which may, for example, result in failing to address all of the goals of a surgical procedure; result in errors that may cause harm to a patient; and/or lengthen the duration of the surgical procedure. Consequently, the ability to recall stored presurgical planning materials and presurgical annotations made thereto prevents or substantially reduces injury to a patent and may avoid subsequent surgical procedures that may be required in order to address items missed during an earlier surgical procedure.

A further benefit of the present disclosure is that a surgeon, for example, may recall previously annotated presurgical planning materials in a sterile environment of an operating room, for example. Particularly, a user is able to digitally recall the annotated presurgical planning materials via one or more display devices, thereby obtaining the benefit of the annotated materials without compromising the integrity of the sterile environment, because the annotated presurgical planning materials in electronic format do not pose contamination risks.

As explained herein, a user is able, for example, to annotate presurgical planning materials at any desired location and, later, freely electronically recall those materials in a sterile environment without risk to a patient. Moreover, the annotated presurgical planning materials may provide information that the user may have otherwise forgotten, thereby having the potential produce a better treatment result.

FIG. 2 shows an example presurgical image 200 of a retina 202. The presurgical image 200 may form a presurgical planning material. The presurgical image 200 of retina 202 may be obtained via a retinal imaging device and stored as a digital image. The presurgical image 200 may be recalled by a surgeon using computer, such as computer 104, for example. Other devices, such as a mobile communications device, a tablet computing device, or laptop computer, or other portable or stationary device, may be used to recall the presurgical image 200. Based on a visual or other type of analysis (e.g., any suitable or desired numerical analysis) of the presurgical image 200, the surgeon may add digital annotations to the presurgical image 200. Annotations may be in the form of text, symbols, colors, audio clips, video clips, or any other type of notation. Further, different types of annotations may be combined. A single application, such as application 122, may be utilized to add one or more types of annotations to presurgical planning materials. In other instances, a plurality of applications may be utilized to add annotations to the presurgical planning materials.

The annotations may provide reminders, surgical notes, anatomy or physiology identifiers, disease identifiers, surgical strategy notations or may identify aspects of the surgical site requiring attention during the surgical procedure. More generally, the user may add any desired annotations whether or not related to an aspect of the image that the surgeon may find helpful in the course of the surgical procedure. Although the example presurgical planning material show in FIG. 2 is in the form of image data, this is provided merely as an example. As explained above, presurgical planning material may be in the form of data or information that a physician or other medical professional may determine to be useful in preparing for a surgical procedure.

In some instances, a presurgical image may be focused on a single aspect of a surgical procedure. However, the scope of the disclosure is not so limited. Rather, a presurgical image may be annotated in the context of any number of purposes, regardless of whether those purposes are related or unrelated to each other. The presurgical image 200 shown in FIG. 2 includes several annotations that may be directed to a singular aspect of a surgical procedure.

The example presurgical image 200 identifies several locations subject to dissection during a surgical procedure, as indicated by the comment annotation 204. These locations are identified by annotations 206, 208, and 210. Each of these annotations may include an associated identifier 212 and a comment 214. The annotation 206 may identify a retina location having strong adherence, as indicated by the text “strong adherence” in the associated comment 214. The annotation 208 may identify a retina location. However, the annotation 208 does not include an associated comment. Annotation 210 also includes the text “diffuse adherence” in the associated comment 214. The annotated presurgical image 200 forms presurgical planning material that may be utilized by a surgeon during a surgical procedure.

While FIG. 2 shows an example presurgical image 200 having a plurality of annotations with or without an associated identifier and/or comment, the disclosure is not so limited. Rather, a presurgical image may include other annotations that may be different in type to those already explained. For example, in some instances, an annotation may include an audio annotation, a video annotation, or any other type of annotation. The different types of annotations may be used separately in separate images or may be combined together in any desired fashion. Moreover, a presurgical image may include any desired annotation. For example, a user may use any type of annotation that may aid the user in recollection of the patient's condition, an aspect of the procedure, or, more generally, that may aid the user in any manner desired.

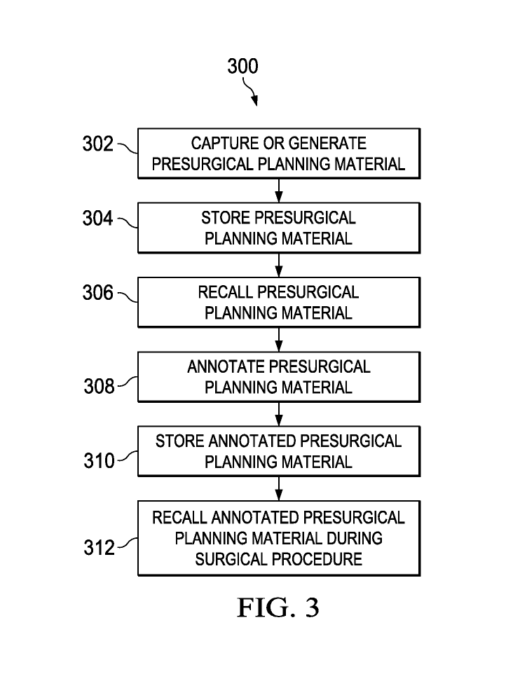

FIG. 3 is an example flowchart 300 for an example method of capturing or generating, annotating, and utilizing presurgical planning material. At 302, presurgical planning material is captured. The presurgical planning material may be in the form of a presurgical image. As explained above, the presurgical image may be any type of data, such as picture data in the form of, for example, a digital image taken through a microscope, an OCT image, or other type of image. Further, in some instances, the image may be a combination of different types of image data. Moreover, the presurgical planning material may be or include non-image data.

At 304, the presurgical planning material is stored. As explained above, the presurgical planning material may be stored, entirely or in part, in a remote database, such as on a server (e.g., server 106), on a local or remote computing device, such as computer 104, or in a surgical device, such as surgical device 102.

At 306, the stored presurgical planning material may be recalled from its storage location. The stored presurgical planning material may be recalled on any device that has access to the stored presurgical planning material. For example, in some instances, a user (such as a physician or other medical professional) may recall the stored presurgical planning material from a computer located in a convenient location, such as a computer in the physician's office, where the user can, for example, comfortably annotate the presurgical planning material. However, the presurgical planning material may be recalled at any desired location on any desired device that has access to the stored presurgical planning material.

At 308, the presurgical planning material is annotated. For example, a user may add information to the presurgical planning material that may aid the user in executing a surgical procedure. In some instances, a user may add text, graphics, audio, or any other type of annotation to the presurgical planning material. The annotations may aid the user in understanding one or more aspects to aid in the execution of a surgical procedure. For example, an annotation may aid the user in understanding one or more aspects of a patient's condition, an aspect of a surgical site, condition of a tissue, an aspect of a procedure to be performed, where and/or how to start the surgical procedure, or any other type of data the user may find helpful in performing the surgical procedure. Annotations added by the user are beneficial in that the annotations reduce the amount of information that a user must commit to memory prior to performing the surgical procedure. The annotations, therefore, reduce the risks of injury that may occur during a surgical procedure by allowing the user to explicitly incorporate information in a manner to quickly recall aspects of the patient or the surgery. This reduces guesswork or loss of information that had been committed or attempted to be committed to the user's memory. Due to the information contained within the annotations and the availability of immediate recall, the duration of the surgical procedure may be reduced. Further, the information provided may provide a better awareness of the totality of circumstances surrounding a surgical procedure, leading to better treatment and a better outcome for the patient.

At 310, the annotated presurgical planning material is stored. As explained above, the annotated presurgical material may be stored entirely or in part remotely, such as on a server (e.g., server 106), locally on the user's computer (which may corresponds to computer 104), or on a surgical device, such as surgical device 102. Storage of the annotated presurgical planning material may be subsequently recalled at any time.

At 312, the annotated presurgical planning material is recalled. For example, the annotated presurgical planning material may be recalled on a display device present inside of a sterile zone of an operating room. Further, the annotated presurgical planning material may be immediately recalled at the will of the user.

The annotated presurgical planning material may be displayed on a display device, such as a monitor, that is separate from a surgical device. In other instances, the annotated presurgical planning material may be displayed on display device of a surgical device, including a display panel or an eyepiece of a visualization device. Thus, the presurgical planning materials may be introduced electronically into a sterile surgical environment without compromising the sterility of the surgical environment.

Further, a user may recall the annotated presurgical planning material using his or her foot. For example, in an instance where an input for a surgical device is a footswitch (such as, for example, where input device 128 of surgical device 102 is a footswitch), the user may articulate the footswitch to recall the annotated presurgical planning materials, allowing the user to keep his or her hands free for other tasks, such as continuing a surgical procedure.

The user may use a footswitch in combination with a display. For example a physician may navigate a user interface, such as a GUI, provided on the display using the footswitch. This allows the user, for example, to dedicate his or her hands to performing a surgical procedure on a patient while simultaneously recalling the annotated presurgical planning materials.

Although FIG. 3 illustrates one implementation of a method for obtaining, preparing, and utilizing presurgical planning material, other methods therefor may include fewer, additional, and/or a different arrangement of operations. For example, an example method may involve adding annotations to, changing annotations, or deleting annotations from presurgical planning materials after the presurgical planning materials are captured without previously storing and recalling the presurgical planning materials. Also, in some instances, the presurgical planning materials may be recalled, annotated, and stored any number of times prior to or even after a surgical procedure. Also, in some instances, a presurgical planning material, whether or not previously annotated, may be recalled during a surgical procedure and annotated during the surgical procedure.

Although the disclosure provides numerous examples, the scope of the present disclosure is not so limited. Rather, a wide range of modification, change, and substitution is contemplated in the foregoing disclosure. It is understood that such variations may be made to the foregoing without departing from the scope of the present disclosure.

What is claimed is:

1. A surgical system comprising:
a first computer-implemented device operable to obtain biomedical information of a patient and store the biomedical information in a digital format to form presurgical planning material;
a second computer-implemented device operable to generate and incorporate an annotation into the presurgical planning material based on received user inputs to form annotated presurgical planning materials, the annotations providing informational aids to assist a medical professional in conducting a surgical procedure; and
a third computer-implemented device operable to recall and present to a user the annotated presurgical planning materials in an electronic format in a sterile surgical environment.

2. The surgical system of claim 1, wherein the first computer-implemented device comprises an imaging device operable to capture an image of a surgical site prior to a surgical procedure.

3. The surgical system of claim 2, wherein the surgical site is a retina, and wherein the imaging device is operable to capture a digital image of a portion of the retina.

4. The system of claim 1, wherein the annotation comprises medically-related information associated with the surgical procedure to assist a user in conducting the surgical procedure.

5. The system of claim 1, wherein the first computer-implemented device, the second computer-implemented device, and the third computer-implemented device are electronically connected via a computer network.

6. The system of claim 5, wherein the second computer-implemented device is located outside of a sterile surgical environment.

7. The system of claim 1, wherein the third computer-implemented device comprises a surgical console, the surgical console comprising a display operable to display the annotated presurgical planning material.

8. The system of claim 1, wherein the first computer-implemented device, the second computer-implemented device, and the third computer-implemented device are the same computer-implemented device.

9. A method of preparing annotated presurgical planning materials and presenting the annotated presurgical planning materials in a sterile surgical environment, the method comprising:
interfacing with a first computer-implemented device to capture presurgical planning material comprising biomedical information;
interfacing with a second computer-implemented device to annotate the presurgical planning material to form annotated presurgical planning material; and
interfacing with a third computer-implemented device to display electronically the annotated presurgical planning material inside of a sterile surgical environment.

10. The method of claim 9, wherein interfacing with a first computer-implemented device to capture presurgical planning material comprising biomedical information comprises capturing an image of a surgical site prior to a surgical procedure.

11. The method of claim 9, wherein the first computer-implemented device is a visualization device and wherein the image of the surgical site is an image of an ocular tissue.

12. The method of claim 9, wherein interfacing with a second computer-implemented device to annotate the presurgical planning material to form annotated presurgical planning material comprises adding medically-related information associated with the surgical procedure to the presurgical planning material to assist a user in conducting the surgical procedure.

13. The method of claim 9, wherein the second computer-implemented device is located outside of a sterile surgical environment.

14. The method of claim 9, interfacing with a third computer-implemented device to display the annotated presurgical planning material inside of a sterile surgical environment comprises displaying the annotated presurgical planning material on a display device of the third computer-implemented device.

15. The method of claim 14, wherein the third computer-implemented device is a visualization device and wherein the display device comprises an eyepiece of the visualization device.

16. The method of claim 9, wherein the first computer-implemented device, the second computer-implemented device, and the third computer-implemented device are the same device.

17. The method of claim 9 wherein the first computer-implemented device, the second computer-implemented device, and the third computer-implemented device are electronically connected via a computer network.

18. The method of claim 9, wherein at least one of the first computer-implemented device, the second computer-implemented device, and the third computer-implemented device is a different device from one or more of the other of the first computer-implemented device, the second computer-implemented device, and the third computer-implemented device.
